(19) United States
(12) Patent Application Publication
(10) Pub. No.: US 2026/0021396 A1
(43) Pub. Date: Jan. 22, 2026

(54) CUSTOMIZABLE LLM-BASED IN-GAME ASSISTANT

(71) Applicant: Sony Interactive Entertainment Inc., Tokyo (JP)

(72) Inventors: Jason Grimm, San Mateo, CA (US); Alex Paiz, San Mateo, CA (US)

(21) Appl. No.: 18/776,144

(22) Filed: Jul. 17, 2024

(51) Int. Cl. A63F 13/54; A63F 13/215; A63F 13/497; A63F 13/79

(52) U.S. Cl. CPC A63F 13/54; A63F 13/215; A63F 13/497; A63F 13/79

(57) ABSTRACT

Artificial intelligence (AI) models are disclosed to provide an in-game assistant that can accompany a user through the user's gameplay and provide audible outputs in video game character voices. The outputs can aid the user by providing summaries of what just happened in the game and what the user might do in the future to advance in the game. The models may include large language models as well as deepfake generators for generating audible outputs in the voices of actual game characters.

### FIELD

The disclosure below relates to technically inventive, non-routine solutions that are necessarily rooted in computer technology and that produce concrete technical improvements. In particular, the disclosure below relates to generative artificial intelligence (AI) models that provide different customized in-game assistance to different video game players.

### BACKGROUND

As recognized herein, video game platforms currently lack the technical capability to provide targeted narratives and dialogues to gamers to update the gamers about things that have happened in past gameplay and that might be helpful for future gameplay. There are currently no adequate solutions to the foregoing computer-related, technological problem.

### SUMMARY

Accordingly, in one aspect an apparatus includes at least one processor system programmed with instructions to execute a video game and, while the video game is executing, receive input from a user. The input requests an output related to one or more aspects of the video game, where the one or more aspects are aspects that have already been played by the user. The instructions are also executable to, based on the input, execute a model to identify data to present as the output. The instructions are further executable to, based on the identification, present the output in a voice of a video game character from the video game.

In some example instances, executing the video game may include pausing the video game to present the output. Also in various example instances, the output may include a summary of one or more game actions that the user has performed in the past and/or a summary of one or more plot aspects related to the video game. The one or more plot aspects may be related to parts of the video game that the user has already played.

In certain examples, the video game character may be a narrator of the video game. Additionally or alternatively, the video game character may be a character currently being played by the user as part of the video game.

Still further, in some example implementations, the model may be a generative model such as a large language model (LLM), while the input from the user may include audible input.

Additionally, in some example embodiments the input may be first input, the output may be a first output, and the data may be first data. Here, the at least one processor system may also be programmed with instructions to, while the video game is executing in a same game instance as when the first output is presented, receive second input from the user. The second input may request a second output related to a future action the user desires to perform in the video game. Based on the second input, the instructions may then be executed to execute the model to identify second data to present as the second output. The instructions are then executable to present the second output in the voice of the video game character from the video game based on the identification of the second data. In various non-limiting examples, the second output may indicate a way for the user to navigate around an in-game obstacle, an action that the user should perform next to progress in the video game, and/or an in-game virtual geographic location to which the user should navigate to progress in the video game.

In another aspect, a method includes receiving input from a user. The input requests an output related to one or more aspects of a video game, where the one or more aspects are aspects that have already been played by the user. The method also includes, based on the input, executing a model to identify data to present as the output. The method then includes, based on the identification, presenting the output to the user.

In certain non-limiting examples, the output may be presented in a voice of a video game character from the video game. Also in certain non-limiting examples, the output may be customized in a speaking style preferred by the user.

Also in various examples, the output may include a summary of one or more game actions that the user has performed in the past and/or a summary of one or more game actions that the user can perform in the future to advance in the video game.

In still another aspect, an apparatus includes at least one computer readable storage medium (CRSM) that is not a transitory signal. The at least one CRSM includes instructions executable by a processor system to receive input from a user, with the input requesting an output related to one or more aspects of a video game. The instructions are also executable to, based on the input, execute a generative model to identify data to present as the output. The instructions are then executable to, based on the identification, present the output to the user.

In some non-limiting instances, the one or more aspects may be aspects that have already been played by the user.

Also in some non-limiting instances, the input may include an audible request for a reminder of the one or more aspects as played by the user in the past, where the output may be presented in a voice of a video game character from the video game. Additionally, the output may summarize, in conformance with the audible request, one or more prior actions taken by the user in the video game.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIGS. 2-4 show illustrations of a video game player conversing back and forth with an in-game AI assistant that accompanies the player throughout a video game consistent with present principles;

FIG. 5 shows example logic in example flow chart format that may be executed by a system/apparatus consistent with present principles;

FIG. 6 shows example artificial intelligence (AI) architecture that may be used consistent with present principles; and

FIG. 7 shows an example settings graphical user interface (GUI) that may be used to configure one or more settings of a system/apparatus to operate consistent with present principles.

### DETAILED DESCRIPTION

The detailed description below provides technical systems and methods for implementing a video game “what just happened” bot. The assistant can use an LLM to give a player responses to questions the player asks, and it can do so in the voice of a character from the video game. The player can therefore have a constant companion that's with the player as the player progresses through the game, with the character voice helping the user stay immersed in the game itself.

The player can ask the assistant things like, “tell me about this quest”, “I have no idea what to do next, tell me where to go/what to do”, and “remind me what I've been doing in the game recently and bring me up to speed.” The assistant can then provide not just game-specific information that conforms to the user's request, but also console-wide information (e.g., the player is getting notification, the player's controller battery is running low, the player's friends just came online, the player's friends are inviting player to play a different game, etc.). The outputs can also be customized and tuned to the player in terms of length of output as well as speaking style preferred by the user. The customized outputs can therefore be generated based on past player messages to others, how fast the player goes through menus, etc. to determine a tone and dialect that's similar to/preferred by/appealing to the player themselves for providing audible output to that specific player.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

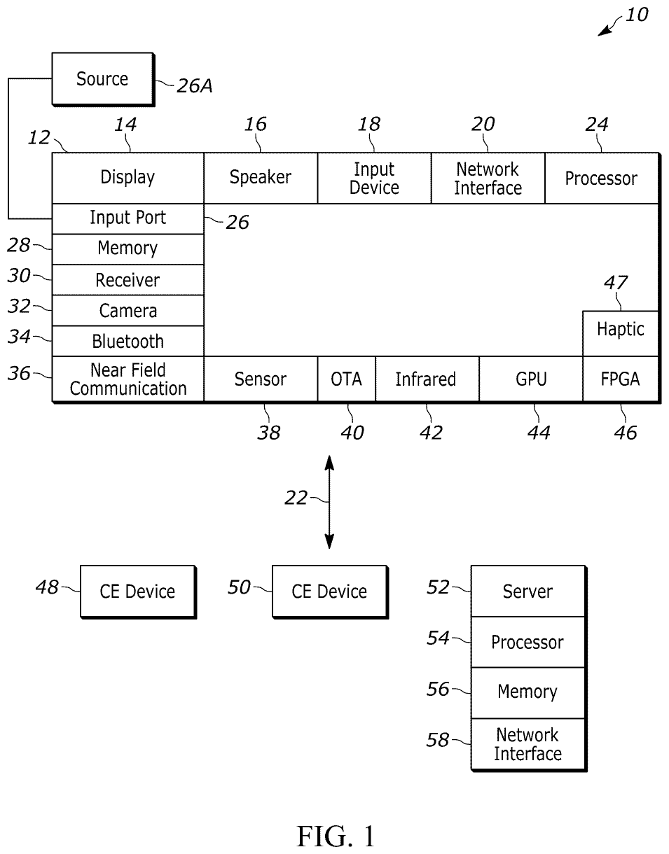

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

Also note before describing other figures that selectors and options on the GUIs discussed below may be selected via cursor input, touch input to the touch-enabled display on which the GUI is presented, using voice input, and/or using other input methods.

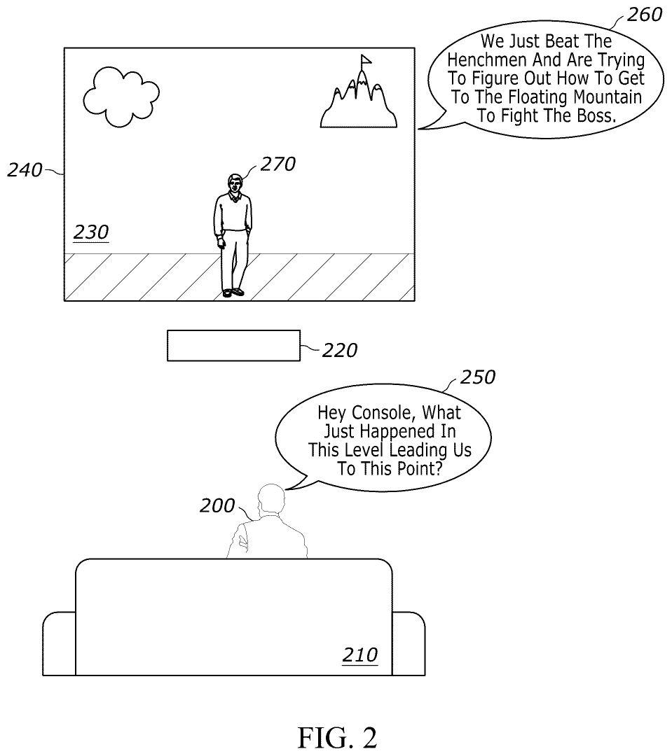

Now in reference to FIG. 2, suppose a video game player 200 has started to play a video game again after not playing the game for a few weeks. The video game player picks the game up by resuming gameplay mid-level on a particular level where the player stopped playing the game last time. The video game itself might be stored and executed by a local console 220, and/or may be streamed over the Internet from a cloud server.

As illustrated in FIG. 2, the player 200 is sitting on a couch 210 while playing the video game through the console 220 and/or server, with the console/server controlling a connected television display 240 to present video game video 230. Then while still playing the game, the user might say an audible trigger to cue an artificial intelligence-based model executing at the console 220 and/or server to process ensuing user input. Here, the trigger comprises the player 200 saying, “Hey console,” which a microphone on the console 220 (or connected device) may detect for the trigger to then be recognized through speech recognition using the microphone input.

The player 200 can then speak the ensuing user input itself. So suppose the player 200 does not immediately remember where the player 200 left off in the game in terms of plot line, current game level, current lives remaining, current inventory items, current points accumulated, current virtual world location, etc. As such, the player 200 might say, “What just happened in this level leading up to this point?” as illustrated by the speech bubble 250 shown in FIG. 2. That input may also be detected by the microphone and provided to the AI-based model. The AI-based model may then pause the game and process the detected speech as natural language to infer an appropriate response to provide, thus allowing the player 200 to have a dialogue with the AI model to remind the player 200 of where the player 200 stopped playing the game the last time they played it and the in-game circumstances leading up to that point. As such, the AI-based model may be established in part by a large language model (LLM) or other generative pretrained transformer (GPT) model. Still other natural language processing models may also be used. Either way, based on the model's training, the model may be configured to generate a response such as, “We just beat the henchmen and are trying to figure out how to get to the floating mountain to fight the boss.” It may therefore be appreciated that, in the present instance, the model has provided an audible response (represented by speech bubble 260) that summarizes the plot line of the video game up to the point where the user is resuming gameplay again, with the summary also summarizing the player's previous game actions while playing the game according to the plot line.

Moreover, in certain non-limiting examples, the AI model may include a deepfake generator in addition to the LLM. As such, the natural language response generated by the LLM may be input to the deepfake generator to render the audible response (represented by speech bubble 260) in a voice of a video game character 270 from the video game. The character might be a narrator of the video game, a main character of the video game, and/or a character currently being controlled by the player 200 to play the video game.

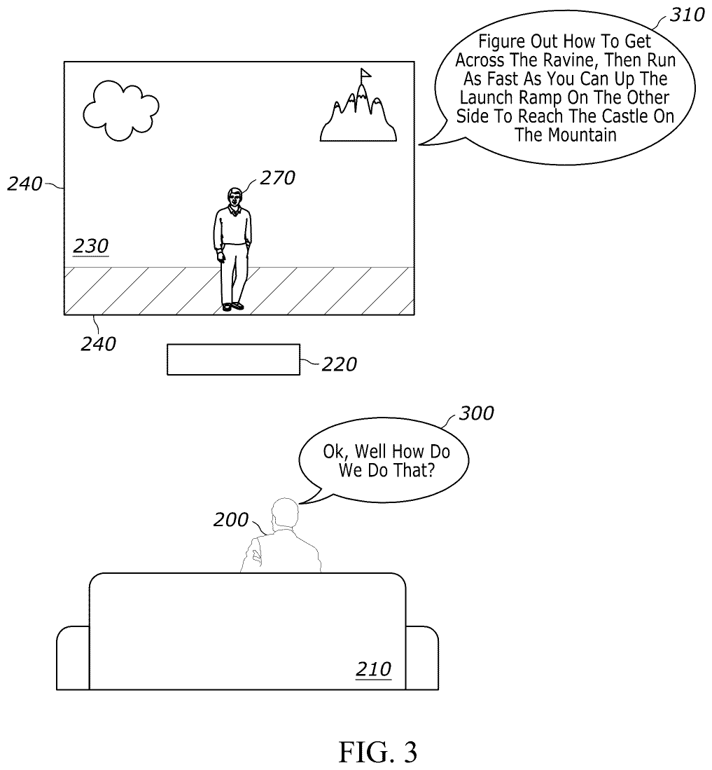

FIG. 3 then shows that the user 200 and AI model may continue to converse back and forth with the video game is still paused (it being further noted that in other examples the game may continue to play out in real time as the conversation continues without pausing as described previously). For example, suppose that the player 200 heard the model's audible response but still does not know how to accomplish the tasks the model set out as a goal for the player 200 through the audible response. The player 200 might then say, “Ok, well how do we do that?” as indicated by speech bubble 300.

AI model may then render another audible response based on the user's detected follow-up utterance. But here, rather than providing an audible summary of one or more game actions that the user has performed in the past, this time the model provides an audible response related to a future game action for the player 200 to perform in the video game for the player 200 to advance in the video game from a current point in the game. As such, this second audible response might indicate, as illustrated via speech bubble 310, “Figure out how to get across the ravine, then run as fast as you can up the launch ramp on the other side to reach the castle on the floating mountain.”

The model or console/server itself may then autonomously un-pause the game responsive playing out the output 310, placing the player 200 right back into live game action to pursue the objectives the model just set out in the second audible response.

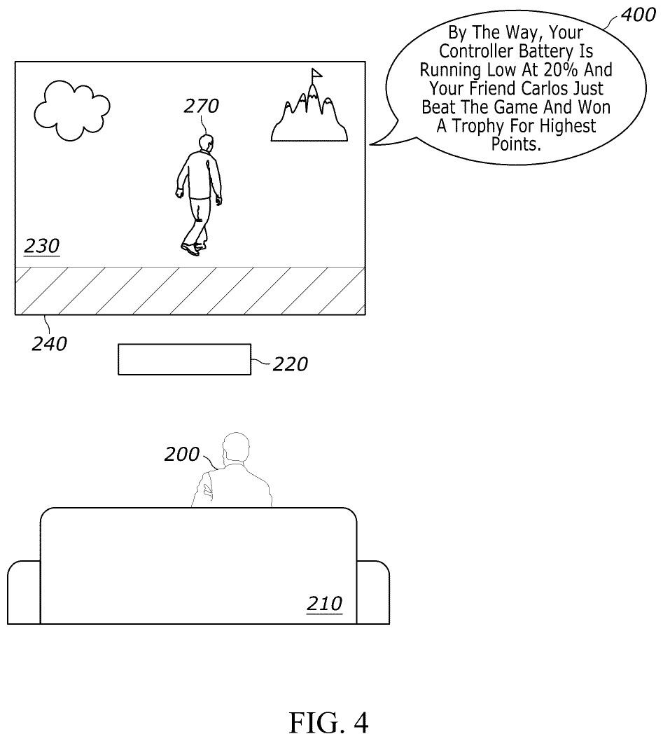

FIG. 4 then illustrates that the player 200 continues to play the game. While the game plays out, without pausing the game again, the model might provide yet another audible output as represented by speech bubble 400. Here, that output includes the model indicating, “By the way, your controller battery is at 20%, and your friend Carlos just beat the game and won a trophy for highest points.” This output may be generated autonomously by the model without a prompt from the player 200. The model may generate this output based on an analysis of data to which the model has access and what inferences of relevancy to the player 200 the model makes based on the data. In the present instance, the data includes current battery charge level for the player's controller (as wirelessly communicated to the console 220 by the controller itself). The data may also include player profile data, game platform data, and game network data accessed through a game platform server for the model to then identify someone connected to the player 200 (through the player's online profile) as achieving a trophy in the same game that is currently being played by the player 200 themselves.

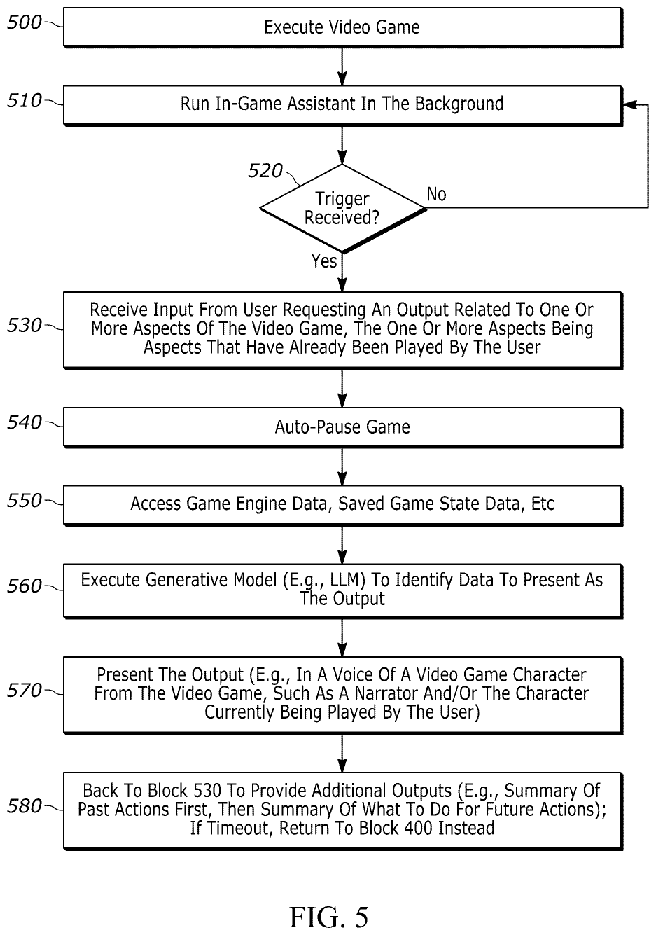

Now in reference to FIG. 5, this figure shows example logic that may be executed by an apparatus such as the CE device 12 (e.g., console) and/or server 52 alone or in any appropriate combination. Thus, in some examples the logic may be executed by a client device alone. In other examples, the logic may be executed by a client device and remotely-located server, where the client device offloads some or all of the logic to the server. Further note that while the logic of FIG. 5 is shown in flow chart format, other suitable logic may also be used.

Beginning at block 500, the apparatus may execute a video game. For example, at block 500 the apparatus may resume a previously-saved game instance for which associated game state data has been stored at the console and/or server. Or the apparatus may start the game anew from the beginning of the game in a new game instance. The logic may then move to block 510 where the apparatus may run an in-game assistant (AI model) consistent with present principles as a background process while the user plays the video game.

The logic may then proceed to decision diamond 520. At diamond 520 the apparatus may determine whether a trigger has been received to cue the AI-based model to listen for ensuing user input. The trigger might be an audible wake-up phrase as described above, but might also be established by a keypress of a particular key on the user's video game controller, input to select a graphical object presented on the video game display (e.g., a pause selector), and/or a free-space hand/arm gesture in the form of a raised hand as may be detected using gesture recognition and a camera imaging the user.

A negative determination may cause the logic to revert back to block 510 to proceed again therefrom. However, responsive to an affirmative determination at diamond 520, the logic may instead proceed to block 530. At block 530 the apparatus may receive input from the user while the video game is still executing. The input may include a request for an output related to one or more aspects of the video game that have already been played by the user, an example of which was described in reference to FIG. 2 above. Also note that the user's request need not necessarily be an audible request, and that a text-based request may additionally or alternatively be provided (e.g., using a hard or soft keyboard to type the text as input to the model).

The logic may then continue to block 540 where the apparatus may auto-pause the game. From there the logic may proceed to block 550 where the apparatus access game engine data indicating a current game state of the user's video game, which might include current in-game virtual world location, current character used, current number of lives remaining, current points earned, current inventory, and other current game state data.

FIG. 5 also shows that the logic may then proceed to block 560. At block 560 the apparatus may execute a generative model such as an LLM to identify (infer) data to present as an output to respond to the user's input from block 530. The apparatus may therefore provide the user's natural language input to the LLM along with the data accessed at block 550 for the LLM to determine a relevant output at block 560. If desired, the output may then be passed through a deepfake generator to present the output verbally and audibly at block 570 in a voice of a video game character from the currently-played video game. The verbal output may therefore be played out through one or more speakers connected to the apparatus and in the user's local environment (e.g., television speakers, loudspeakers, etc.). Again note that the character from the game that is used for the voice of the audible output may be a narrator of the game, an original/main character of the game, and/or another game character that the user is currently controlling to play the video game.

After block 570 the logic may proceed to block 580. At block 580 the logic may revert back to block 530 to provide additional outputs based on additional user inputs that are received while the user continues to play the game (and/or to autonomously provide additional outputs without additional input from the user as described above). The additional outputs may relate to summaries of past in-game player actions and already-played plot aspects, as well as summaries of what the user can perform as future actions in the video game to advance even further within the video game. The subsequent model outputs may therefore be presented while the video game continues to be executed for the same game instance that the user resumed earlier, with those subsequent outputs also being in the same video game character voice as the prior audible response from the model that was presented at block 750.

As one example, an output of a future game action for the user to perform may include an indication of a way for the user to navigate around an in-game obstacle (e.g., virtual rock or virtual door). Additionally or alternatively, an output of a future game action for the user to perform may include an indication of an action for the user to take next to progress in the video game (e.g., an action to further the game's plot line, an action to achieve a goal within the game, and/or a game action in the form of a particular game move or controller button selection sequence for the user to perform). As yet another example, an output of a future action for the user to perform may include an indication of an in-game virtual location to which the user should navigate their game character to progress in the video game.

However, also at block 580, in examples where no subsequent user input is received after the output of block 570 (e.g., received within a threshold preset period of time, such as five seconds), the current input session may timeout and the logic may revert back to block 400. Without timing out, the user may provide subsequent input to the model without having to trigger the model again via a wake-up phrase, while after timing out the user would have to utter the wake-up phrase again to continue verbally interacting with the model.

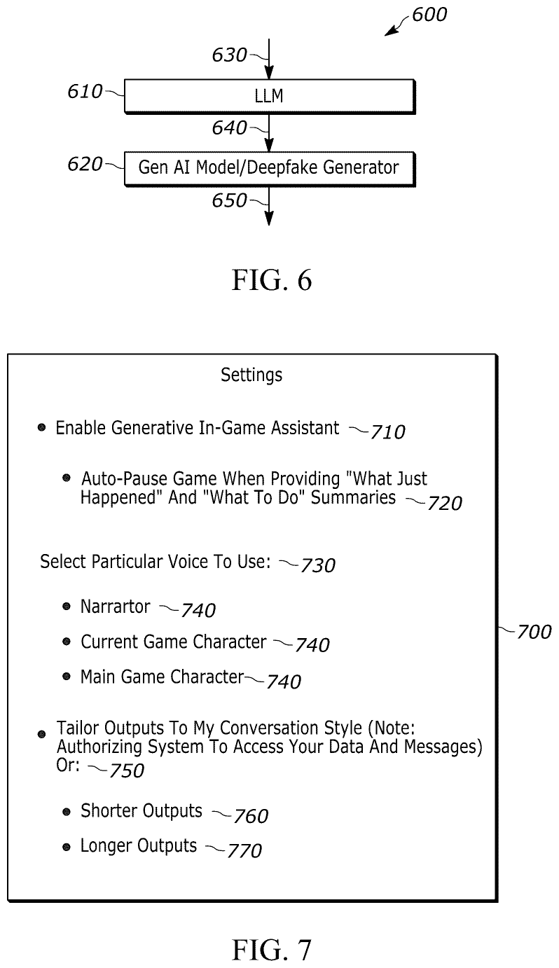

Turning now to FIG. 6, example artificial intelligence (AI) model architecture 600 is shown that may be implemented in an apparatus consistent with present principles. The architecture 600 may be constructed with a first model 610 that includes one or more LLMs, generative pretrained transformers, and/or other machine learning-based models for identifying relevant, personalized outputs to present to a video game player based on voice prompts or other types of prompts from the player. Thus, in addition to or in lieu of an LLM, the model 610 may be established by one or more deep neural networks (NNs), such as one or more convolutional neural networks (CNNs) in particular. The LLM, CNN, and/or other AI-based model 610 may be trained to make inferences of relevant outputs to present to a given player based on current game state data for a video game played by the player as well as data related to the player themselves. The data related to the player themselves might include game platform profile data related to the games previously played by the player, types of games the player likes to play, connections (e.g., friends) of the player connected over the game network, likes and interests of the player, the player's text messaging history from text chats the player has engaged in over the game network, the player's audible input history for voice chats the player has engaged in with others, etc. So, for example, the model 610 may be trained in supervised fashion using a dataset that includes pairs of relevant game-related and player-related data as well as associated ground truth labels for associated outputs. Unsupervised learning, semi-supervised learning, reinforcement learning, and other learning techniques may additionally or alternatively be used to train the model 610.

FIG. 6 also shows that the architecture 600 may include a second model 620 that is different from the first model 610. The second model 620 may be a generative AI model such as a deepfake generator or other audio generation model. The first LLM/model 610 might therefore output a text-based inference for the model 620 to then convert the text into audio using a text-to-speech algorithm for the generated audio to then be read/spoken aloud in the voice of a character from the video game played by the player. The deepfake generator may therefore be trained to generate deepfake audio in the voice of different video game characters from different games. As an example, the generator may be provided audio clips of different video games, with each clip containing audio of a particular game character speaking. Each clip may have a label attached that indicates the name of the associated character speaking in the associated clip. The deepfake generator may then be trained using the clip/label pairs in supervised fashion to configure the deepfake generator to generate other audio for the player's character that includes different words never spoken by the character in the original game content itself.

Describing an example use of the architecture 600, note that game-related and player-related data 630 may be fed into the first model 610 as input for the first model 610 to then determine an output relevant to the player according to correlations identified from the data (e.g., the player's friend beating the same game). As such, an inference 640 of relevant, personalized content may be output by the model 610. The output 640 may then be fed into the second model 620 for the second model 620 to generate deepfake audio 650 for presentation to the player at the player's client device and in the voice of the player's current video game character.

Continuing the detailed description in reference to FIG. 7, it shows an example GUI 700 that may be presented on a display for an end-user to configure one or more settings of an apparatus to operate consistent with present principles. The GUI 700 may be presented as part of a console operating system settings screen or video game settings screen, for example.

As shown in FIG. 7, the GUI 700 may include a first option 710 that is selectable to command the apparatus to enable/turn on a generative in-game assistant, which might colloquially be referred to as a “What Just Happened? Bot”. Therefore, the option 710 may be selected a single time to set or configure the apparatus to, for multiple future game instances, undertake one or more of the actions described above in reference to FIGS. 2-6 to generate and present personalized in-game assistance to a video game player through audible reminders of past plot aspects of the game as well as assistance on how to advance in the game in the future. Other outputs may also be presented based on the assistant being enabled through the option 710, such as notifications about received game network messages and notifications about battery power status for the player's controller battery.

The GUI 700 may also include an option 720. The option 720 may be selectable to specifically set or enable the apparatus to auto-pause playout of the game within the execution environment so that the player can focus on whatever audible output is being provided subsequent to and during the pause.

The GUI 700 may further include a setting 730 at which the user can select a particular character voice in which audible output from the in-game assistant should be presented. Respectively selectable options 740 may therefore be presented as part of the GUI 700 for the player to select the game narrator's voice, a current game character's voice, or a different main character's voice for the assistant to use for its audible outputs.

As also shown in FIG. 7, the GUI 700 may include an option 750 that may be selectable to set or configure the in-game assistant to tailor its audible outputs to the particular human player's conversation style (e.g., in addition to being presented in the video game character's deepfaked voice). Note that the text of the option 750 explicitly indicates that the player is authorizing the system to access the player's data and messaging history, providing the player notice that certain personal data will be accessed to do so to provide transparency to the player.

In terms of the player's conversation style itself, one or more LLMs and/or natural language processing algorithms may be executed to identify the style for the in-game assistant to then mimic that style. For example, speaking speed and cadence may be identified from past detected speech, as well as the player's accent, dialect, tone, etc. Samples of the player's speech may also be analyzed to infer whether the player provides long thoughts or terse thoughts when audible conversing with others. These types of parameters may be identified from the player's game network text messaging history, from the player's game network audible conversations (e.g., with other networked players while playing a game), and/or based on past voice prompts the player has provided to the in-game assistant itself.

However, also note that the GUI 700 may include options 760, 770 as well. So, for example, the user might not want audible outputs to be provided in the same speaking style as the player themselves. In such an instance, instead of selecting the option 750, the user might instead select the option 760 to provide short audible outputs or select the option 760 to provide longer audible outputs.

It may now be appreciated that present principles provide an in-game AI bot companion that can provide relevant game content and game help on demand, in real-time, to a human player. The AI assistant can provide responses to questions the player asks about the game, and the assistant can accompany the player through the entire game as the player plays it. The player might also ask the assistant and get a response to a request to introduce the player to a certain in-game quest. Or the player might say that the player has no idea what to do next and ask the AI assistant to tell the player where to go/what to do next in the game. The AI assistant may therefore be trained to summarize game aspects for the player to cognitively bring the player back up to speed on the context of what the player was doing before they stopped playing the game days or weeks before, getting the player back on track based on the context of the player's previous gameplay from back then. The AI model may also have access to the game engine data to determine what comes next in the game plot-wise and provide helpful gameplay suggestions to the player.

Also note that in addition to or in lieu of audible outputs, text output in the form of closed captioning or other text may be presented on a game display in conformance inferences by the AI assistant. But either way, the AI assistant may be trained to give game-specific and even non-game-specific outputs to the player. Non-game-specific outputs might relate to controller battery level, what other games the player's online friends are currently playing, a notification that the player's friends just logged in/came online, and/or a notification that a message that has just been received by the player over the game network.

The AI assistant may even respond to the player in way it thinks the player wants to be responded to based on how the player interacts with the AI assistant, the game console, the game platform, and/or the game itself. To do so, the AI model might parse messages that are sent out by the player, determine whether the user goes through game menus quickly or slowly (and correlating that to a fast or slow speaking style, respectively), etc. Those types of data may then be used as training data inputs to train a personalized in-game assistant to speak like the player themselves in subsequent outputs.

While the particular embodiments are herein shown and described in detail, it is to be understood that the subject matter which is encompassed by the present application is limited only by the claims.

What is claimed is:

1. An apparatus, comprising:
at least one processor system programmed with instructions to:
execute a video game;
while the video game is executing, receive input from a user, the input requesting an output related to one or more aspects of the video game, the one or more aspects being aspects that have already been played by the user;
based on the input, execute a model to identify data to present as the output; and
based on the identification, present the output in a voice of a video game character from the video game.

2. The apparatus of claim 1, wherein executing the video game comprises pausing the video game to present the output.

3. The apparatus of claim 1, wherein the output comprises a summary of one or more game actions that the user has performed in the past.

4. The apparatus of claim 1, wherein the output comprises a summary of one or more plot aspects related to the video game, the one or more plot aspects being related to parts of the video game that the user has already played.

5. The apparatus of claim 1, wherein the video game character is a narrator of the video game.

6. The apparatus of claim 1, wherein the video game character is a character currently being played by the user as part of the video game.

7. The apparatus of claim 1, wherein the model comprises a large language model (LLM).

8. The apparatus of claim 1, wherein the input from the user comprises audible input.

9. The apparatus of claim 1, wherein the input is first input, wherein the output is a first output, wherein the data is first data, and wherein the at least one processor system is programmed with instructions to:
while the video game is executing in a same game instance as when the first output is presented, receive second input from the user, the second input requesting a second output related to a future action the user desires to perform in the video game;
based on the second input, execute the model to identify second data to present as the second output;
based on the identification of the second data, present the second output in the voice of the video game character from the video game.

10. The apparatus of claim 9, wherein the second output indicates a way for the user to navigate around an in-game obstacle.

11. The apparatus of claim 9, wherein the second output indicates an action that the user should perform next to progress in the video game.

12. The apparatus of claim 9, wherein the second output indicates an in-game virtual location to which the user should navigate to progress in the video game.

13. A method, comprising:
receiving input from a user, the input requesting an output related to one or more aspects of a video game, the one or more aspects being aspects that have already been played by the user;
based on the input, executing a model to identify data to present as the output; and
based on the identification, presenting the output to the user.

14. The method of claim 13, wherein the output is presented in a voice of a video game character from the video game.

15. The method of claim 14, wherein the output is customized in a speaking style preferred by the user.

16. The method of claim 13, wherein the output comprises a summary of one or more game actions that the user has performed in the past.

17. The method of claim 13, wherein the output comprises a summary of one or more game actions that the user can perform in the future to advance in the video game.

18. An apparatus, comprising:
at least one computer readable storage medium (CRSM) that is not a transitory signal, the at least one CRSM comprising instructions executable by a processor system to:
receive input from a user, the input requesting an output related to one or more aspects of a video game;
based on the input, execute a generative model to identify data to present as the output; and
based on the identification, present the output to the user.

19. The apparatus of claim 18, wherein the one or more aspects are aspects that have already been played by the user.

20. The apparatus of claim 18, wherein the input comprises an audible request for a reminder of the one or more aspects as played by the user in the past, wherein the output is presented in a voice of a video game character from the video game, and wherein the output summarizes, in conformance with the audible request, one or more prior actions taken by the user in the video game.
